(19) United States
(12) Patent Application Publication
(10) Pub. No.: US 2008/0014473 A1
(43) Pub. Date: Jan. 17, 2008

(54) Fuel cell system and purging method for fuel cell system

(75) Inventor: Toru Nakakubo, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/808,944

(22) Filed: Jun. 14, 2007

(30) Foreign Application Priority Data
Jul. 11, 2006 (JP) 2006-190425
May 31, 2007 (JP) 2007-145159

(51) Int. Cl. H01M 8/04; H01M 8/00

(52) U.S. Cl. 429/13; 429/25

(57) ABSTRACT

There are provided a fuel cell system and a purging method for a fuel cell system, in which an impurity in a fuel flow path can be discharged with high efficiency by a simple structure, and lowering in output can be suppressed, thus enabling size reduction. The fuel cell system includes a fuel cell having a power generating portion; a fuel reservoir for supplying a fuel to the fuel cell; a fuel flow path for allowing the fuel in the fuel reservoir to flow in the fuel cell system; a pressure control mechanism for controlling a fuel gas pressure in the fuel flow path to be higher than a normal operating pressure; and an impurity discharging mechanism, which is operated based on a control due to a higher pressure of the pressure control mechanism to discharge the impurity in the fuel flow path to an outside of the fuel cell.

### BACKGROUND OF THE INVENTION

1. Field of the Invention

The present invention relates to a fuel cell system and a purging method for a fuel cell system.

2. Description of the Related Art

Hitherto, various types of fuel cells are researched and developed. Of those, a polymer electrolyte fuel cell (or proton exchange membrane fuel cell) is widely researched and developed as an automotive or residential power generation apparatus for the reasons that the operating temperature of the polymer electrolyte fuel cell is lower than that of other types of fuel cells, the electrolyte used therein is a polymer electrolyte membrane and can therefore be easily handled, or the like.

A general structure of the polymer electrolyte fuel cell will be described with reference to FIG. 2. For the electrolyte, a polymer electrolyte membrane is used. Power generation is performed by supplying, with respect to a membrane electrode assembly 2 having catalyst electrode layers provided on the both sides of the polymer electrolyte membrane, a fuel such as hydrogen gas to one (anode 4) of the catalyst electrode layers, and supplying an oxidizer such as air to the other catalyst electrode layer (cathode 3). At that time, water is generated as a product. The reaction formulae in the anode 4 and the cathode 3 are as follows.

Anode: H₂->2H⁺+2e⁻

Cathode: ½O₂+2H⁺+2e⁻->H₂O

The theoretical voltage of one membrane electrode assembly set is about 1.23 V, and in a normal operation state, the membrane electrode assembly set is used at a theoretical voltage of about 0.7 V in most cases. Thus, in a case where a higher voltage is required, or where a high output density is required, a plurality of fuel cell units are stacked and are electrically connected to each other in series. FIG. 2 illustrates an example in which three layers of fuel cell units are used. A stack structure as described above is called a fuel cell stack.

FIG. 2 is also used to describe a structure of a fuel flow path in a general fuel cell. The term “fuel flow path” herein employed refers to a flow path through which a fuel supplied from a fuel supply source flows in a fuel cell system.

That is, the term “fuel flow path” refers to a path including a flow path 7 for guiding a fuel from the fuel supply source through a first valve (control valve) 5 to a fuel cell 1, a flow path 4 provided in the anode of the fuel cell, and a flow path 8 extending from the fuel cell to a discharge mechanism for discharging the fuel in the fuel cell to an outside through a second valve 6 (relief valve). In the present invention, in particular, a flow path in the anode is called an anode flow path or simply called an anode.

Air as the oxidizer is supplied to the cathode 3 through an air intake port (not shown).

During electric power generation of the fuel cell, the electrolyte membrane used for the polymer electrolyte fuel cell allows a minute amount of air to pass therethrough. Therefore, during the electric power generation, an impurity gas such as nitrogen in the air and water vapor generated by the reaction is accumulated in the fuel flow path.

In particular, in a recirculating or dead-ended fuel cell with high fuel utilization efficiency, the power generation characteristics of the fuel cell will be degraded due to the thus accumulated impurity gas.

Therefore, in Japanese Patent Application Laid-Open No. 2004-171967, in the dead-ended fuel cell, a purge valve is provided in a fuel flow path and a purge operation is performed during power generation, thereby preventing degradation of the characteristics.

Further, U.S. Pat. No. 6,423,437 discloses a technique in which, in a dead-ended small fuel cell, a nylon film is provided in a fuel flow path instead of provision of an active purge valve, thereby allowing water vapor to pass therethrough, whereby the water vapor in the fuel flow path is discharged. As a result, degradation of the power generation characteristics is prevented.

In order that polymer electrolyte membranes used for a fuel cell maintain a mechanical strength and a fuel is prevented from passing therethrough, a polymer electrolyte membrane having a thickness of about 50 to 100 μm is generally used. The strength of such a polymer electrolyte membrane is about 300 to 500 kPa (3 to 5 kg/cm²). Accordingly, in order to prevent breakage of the membrane due to a differential pressure, it is desirable to perform the control such that the differential pressure between the anode and the cathode of the fuel cell is equal to or lower than 50 kPa (0.5 kg/cm²) in normal time, and equal to or lower than 100 kPa (1 kg/cm²) even in emergency situations.

Therefore, hitherto, as in Japanese Patent Application Laid-Open No. 2004-31199, there has been proposed a technique related to a small pressure-reducing valve used for a fuel cell. The use of such a pressure-reducing valve allows supply of a fuel while maintaining a pressure in the anode constant.

Further, in a case where the pressure in an anode is higher than the above-mentioned pressure, in order to avoid breakage of polymer electrolyte membranes, the pressure in the anode needs to be reduced.

In view of the above, in Japanese Patent Application Laid-Open No. H10-284098, there has been proposed a mechanism which includes a safety valve in a fuel flow path connected to an anode of a fuel cell, and prevents the damage of a fuel cell system by discharging a fuel gas to an outside when the pressure in the flow path becomes higher than a set pressure.

On the other hand, for an automotive or stationary large fuel cell, there is adopted, for a fuel and an oxidizer, instead of the dead-ended type, a system (flow system) that allows the fuel to flow continuously in an amount larger than an amount required for the power generation. In some cases, in order to enhance the fuel utilization efficiency, an excessive amount of the fuel may be circulated for use.

In the flow system, the flow rate is high and a contaminated impurity gas is also discharged together. Therefore, the purge operation is performed at the time of activation and is also performed for eliminating water droplets remaining in a cathode flow path. Japanese Patent Application Laid-Open No. 2006-86006 discloses that, when a foreign matter is deposited in a gas flow path, in order to discharge the foreign matter, the pressure in the flow path is increased.

However, in the purging method for preventing degradation of the power generation characteristics in the conventional example, there is a fear that, in a case where the pressure in the flow path is low when the fuel flow path is purged, the purging may not be performed sufficiently, and air may flow back from the outside to be contaminated into the fuel, thereby degrading the power generation characteristics.

On the other hand, as described above, in Japanese Patent Application Laid-Open No. 2004-31199 and Japanese Patent Application Laid-Open No. H10-284098, there has been made an attempt that the pressure-reducing valve is mounted for controlling the pressure of a fuel to be supplied, or the safety valve is mounted for preventing abnormal increase of the pressure in the fuel flow path.

However, also in those techniques, a requisite pressure is set at the time of normal operation, and there is no means for varying a secondary pressure at the time of purging. Therefore, those techniques are not satisfactory for performing purging sufficiently.

Further, the foreign matter discharge means according to Japanese Patent Application Laid-Open No. 2006-86006 generally keeps supplying a fuel gas by a flow. In this system, a flow path outlet is always open, so that the pressure in the flow path is determined by a flow path resistance. For an effective supply of a gas, in general, it is desirable to set the flow path resistance to be low. However, when the flow path resistance is low, in order to increase the pressure, a larger amount of gas is required to be supplied. Further, for effective purging, a pressure change due to increase in pressure and discharge in a short period of time is important. However, in the case of the flow system, in particular, when the flow path resistance is set to be high, it is difficult to reduce the pressure in a short period of time and to release the gas in the flow path at once. That is, in the flow system, in order to enhance the power generation performance and to perform rapid gas replacement, a low flow path resistance is required, while in order to efficiently increase the pressure of the flow path, a high flow path resistance is required, and it is difficult to strike a balance therebetween.

### SUMMARY OF THE INVENTION

In order to solve the above-mentioned problems, the present invention is directed to a fuel cell system in which an impurity in a fuel flow path can be discharged with high efficiency by a simple structure to suppress lowering of an output and size reduction can be realized and to a purging method for a fuel cell system.

According to the present invention, a fuel cell system is provided which includes a fuel cell having a power generating portion; a fuel flow path for allowing a fuel gas supplied from a fuel supply source to flow in the fuel cell system; a pressure control mechanism for controlling a fuel gas pressure in the fuel flow path to be higher than a normal operating pressure; and an impurity discharging mechanism which operates based on a control due to a higher pressure of the pressure control mechanism to discharge an impurity in the fuel flow path to an outside of the fuel cell.

Further, the fuel cell system according to the present invention is characterized by further including a fuel reservoir as the fuel supply source.

Further, the fuel cell system according to the present invention is characterized in that the pressure control mechanism includes a control valve for controlling supply of a fuel provided in the fuel flow path located between the fuel supply source and the fuel cell and is configured such that a pressure in the fuel flow path can be controlled to be higher than the normal operating pressure by the control valve.

Further, the fuel cell system according to the present invention is characterized in that the control valve is provided in a bypass flow path of the fuel flow path located between the fuel supply source and the fuel cell.

Further, the fuel cell system according to the present invention is characterized in that the pressure control mechanism includes a fuel pressure control device for controlling a pressure of a fuel in the fuel reservoir and is configured such that a pressure in the fuel flow path can be controlled to be higher than the normal operating pressure by the fuel pressure control device.

Further, the fuel cell system according to the present invention is characterized in that the impurity discharging mechanism includes a valve which opens at a predetermined pressure in a discharging portion and is configured such that the impurity in the fuel flow path can be discharged to the outside of the fuel cell by a control of the valve which opens at the predetermined pressure.

Further, according to the present invention, there is provided a purging method for a fuel cell system which includes a fuel cell having a power generating portion, and a fuel flow path for allowing a fuel gas supplied from a fuel supply source to flow in the fuel cell system and in which an impurity in the fuel flow path is discharged to an outside of the fuel cell, the method including controlling a fuel gas pressure in the fuel flow path to be higher than a normal operating pressure and operating an impurity discharging mechanism based on a control due to the higher pressure to discharge the impurity in the fuel flow path to the outside of the fuel cell.

Further, the purging method for a fuel cell system according to the present invention is characterized in that the control of making the fuel gas pressure higher than the normal operating pressure is performed by controlling a fuel supply device provided in the fuel flow path located between the fuel supply source and the fuel cell.

Further, the purging method for a fuel cell system according to the present invention is characterized in that the control of making the fuel gas pressure higher than the normal operating pressure is performed by controlling a fuel gas pressure in a fuel reservoir included, as the fuel supply source, in the fuel cell system.

Further, the purging method for a fuel cell system according to the present invention is characterized in that the discharge of the impurity to the outside of the fuel cell is performed by controlling a valve which opens at a predetermined pressure.

According to the present invention, there can be achieved a fuel cell system and a purging method for a fuel cell system, in which an impurity in a fuel flow path can be discharged with high efficiency by a simple structure, and lowering in output can be suppressed, thus enabling size reduction.

Further features of the present invention will become apparent from the following description of exemplary embodiments with reference to the attached drawings.

### BRIEF DESCRIPTION OF THE DRAWINGS

FIG. 1 is a schematic diagram illustrating a fuel cell system according to an embodiment of the present invention.

FIG. 2 is a schematic structural view illustrating a general structure of a polymer electrolyte fuel cell.

FIG. 3 is a flow chart illustrating an impurity discharging method according to an embodiment of the present invention.

FIG. 4 is a schematic diagram illustrating a fuel cell system according to Example 1 of the present invention.

FIG. 5 is a sectional diagram of a structure of a regulator, used in Example 2 of the present invention.

FIG. 6 is a sectional diagram of a structural example in which a pin is used for a mechanism for increasing a pressure in a regulator according to Example 2 of the present invention.

FIG. 7 is a sectional diagram of a structural example in which a chamber filled with an operating fluid is provided, as a mechanism for enhancing a pressure, adjacent to a diaphragm in the regulator according to Example 2 of the present invention.

FIG. 8 is a sectional diagram of a structural example in which a relief valve is used as a second valve in an impurity discharging mechanism according to Example 3 of the present invention.

FIGS. 9A and 9B are views illustrating the relief valve according to Example 3 of the present invention, in which FIG. 9A is a plan view of the relief valve, and FIG. 9B is a bottom view of the relief valve.

FIG. 10 is a schematic diagram illustrating a fuel cell system according to Example 4 of the present invention.

FIG. 11 is a diagram of a structural example in which a heater is provided to a fuel reservoir, as a mechanism for increasing a pressure according to Example 4 of the present invention.

FIG. 12 is a diagram of a structural example in which a volume inside the fuel reservoir is made variable as a mechanism for increasing a pressure according to Example 4 of the present invention.

### DESCRIPTION OF THE EMBODIMENTS

A description will be made of a fuel cell system and a purging method for a fuel cell system according to an embodiment of the present invention.

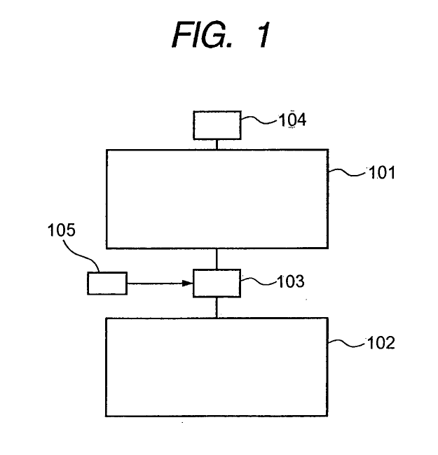

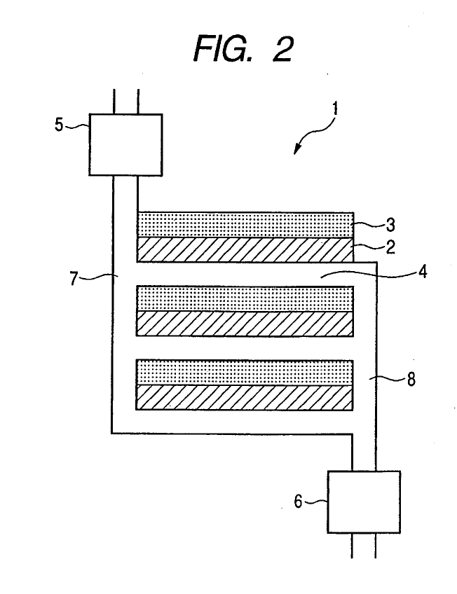

FIG. 1 illustrates a schematic diagram of the fuel cell system of this embodiment.

In FIG. 1, there are provided a fuel cell 101, a fuel reservoir 102, a first valve 103, a second valve 104, and a pressure control mechanism (hereinafter, referred to as a mechanism for increasing pressure) 105 for controlling a fuel gas pressure in a fuel flow path such that the fuel gas pressure is higher than a normal operating pressure.

In the embodiment of the present invention, a fuel is stored in the fuel reservoir 102 as a fuel supply source. The fuel is supplied to an anode of the fuel cell 101 through the fuel flow path. In the following, description will be made by taking, as an example, a case where the fuel reservoir 102 is incorporated in the fuel cell system, but the present invention is not limited thereto. The present invention may be applied to a case where the fuel supply source is provided outside the fuel cell system and the fuel is supplied to the fuel cell system through a fixed pipe or the like.

As a fuel, for example, hydrogen can be used. By filling the fuel reservoir 102 with a hydrogen storage alloy or the like, hydrogen can be efficiently stored therein. A liquid fuel such as methanol may be retained in the fuel reservoir, and through successive reforming, hydrogen gas can be supplied to the fuel cell. In the fuel flow path, there are provided the first valve 103 for controlling supply of the fuel from the fuel reservoir 102 to the fuel cell 101, and the second valve 104 for discharging the fuel to the outside of the fuel flow path. There is further provided a mechanism 105 for increasing the pressure in the fuel flow path based on a purge instruction to the fuel cell. As such a mechanism 105, there may preferably be used a regulator valve whose set pressure can be regulated in accordance with an instruction from outside.

A second valve 104 is provided as an impurity discharging mechanism which operates based on a control due to a higher pressure to thereby discharge an impurity in the fuel flow path to an outside of the fuel cell. As the valve 104, one is preferably used which is so configured as to open at a predetermined pressure. As such a valve, there may be included a so-called relief valve because of having a simple structure and being suitable for size reduction. By increasing the pressure in the flow path so as to exceed the releasing pressure of the relief valve, an impurity in the fuel flow path can be discharged to an outside of the fuel cell without necessity of providing a complicated control device. Further, there may also be adopted such configuration that an ordinary valve that opens/closes in accordance with an instruction from outside is provided as the second valve 104, and a control circuit combined with a pressure sensor is used to thereby discharge an impurity in the fuel flow path to an outside of the fuel cell.

As the oxidizer, air can be taken in from the air intake port through natural diffusion. A generated electric power is supplied to an external device through an output terminal.

Next, description will be made of an impurity discharging method according to this embodiment.

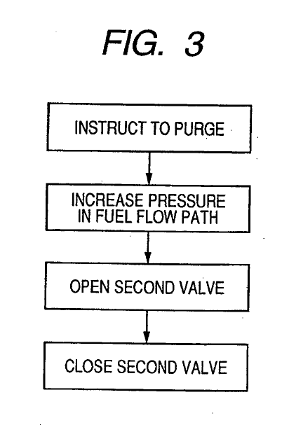

FIG. 3 is a flow chart for illustrating the impurity discharging method according to this embodiment.

When supplying a fuel, first, the first valve 103 is opened during normal power generation of the fuel cell, and the fuel is supplied to the fuel cell 101.

On the other hand, the second valve 104 is closed. In this state, when the fuel cell 101 receives a purge instruction, first, the mechanism 105 for increasing the pressure in the fuel flow path is activated, and the pressure in the fuel flow path becomes higher than that during the normal power generation.

Thereafter, the second valve 104 is opened. The second valve 104 is then closed. The timing at which the purge instruction is given to the fuel cell may be determined based on passage of a predetermined period of time after the power generation, or by monitoring the voltage of the fuel cell and detecting that the voltage has become lower than a predetermined value. Alternatively, the timing may be determined by measuring the gas concentration in the fuel flow path and confirming that the impurity concentration has become higher than a predetermined value or that a fuel concentration has become lower than a predetermined value.

Further, the timing at which the second valve 104 is closed after the opening may be determined based on passage of a predetermined period of time, or by confirming that a cumulative flow rate of the discharged fuel has reached a predetermined value. Further, the timing may be determined by confirming that the pressure in the fuel flow path has become lower than a predetermined value, or by confirming that the voltage of the fuel cell has become higher than a predetermined value. Alternatively, the timing may be determined by confirming that the impurity gas concentration in the fuel flow path has become lower than a predetermined value, or that the fuel concentration has become higher than a predetermined value.

Further, it is desirable that the second valve 104 be provided in the fuel flow path and on a downstream side of the anode of the fuel cell 101 in a flow direction of the fuel at the time of normal power generation because the impurity can be discharged with higher efficiency.

By the impurity discharging mechanism and the method therefor according to the present invention described above, the power generation characteristics of the fuel cell can be stabilized and the size of the fuel cell system can be reduced. Accordingly, the impurity discharging mechanism and the method therefor are useful particularly for a power generation apparatus or device using the polymer electrolyte membrane.

### EXAMPLES

Hereinafter, examples of the present invention will be described.

### Example 1

In Example 1, description will be made of a fuel cell system to which the present invention is applied. In this example, with the exception that electromagnetic valves are used for the first valve 103 and the second valve 104 according to the embodiment illustrated in FIG. 1 described above, the fuel cell system has basically the same structure as that of the above embodiment.

In this example, when the purge instruction is given according to the flow chart of FIG. 3, the mechanism 105 for increasing the pressure in the fuel flow path issues an instruction to the first valve 103, for opening the valve wider than that at the time of normal power generation.

As a result, the pressure in the fuel flow path is higher than that at the normal power generation.

Next, an instruction of opening the second valve 104 is issued, thereby performing a discharge operation. After completion of the discharge operation, the first valve 103 is returned to a normal opening degree, and the second valve 104 is closed.

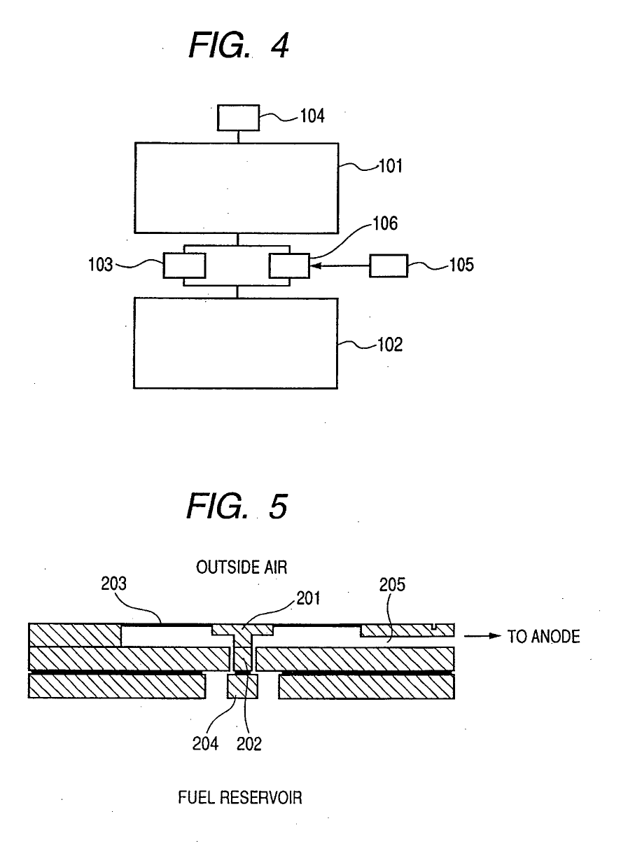

The first valve 103 for supplying the fuel during the normal power generation can be operated by the mechanism 105 for increasing the pressure, but a structure as illustrated in FIG. 4 may also be provided.

That is, as illustrated in FIG. 4, there are provided a bypass flow path from the fuel reservoir 102 to the fuel cell 101, and a third valve 106 in the bypass flow path. In order to increase the pressure in the fuel flow path, the third valve 106 may be used. Incidentally, in FIG. 4, the elements which are the same as those in the fuel cell system illustrated in FIG. 1 are identified by like numerals.

### Example 2

In Example 2, description will be made of a structural example in which a regulator is used for the first valve 103 in the embodiment illustrated in FIG. 1 described above.

FIG. 5 is a sectional diagram of a structure of the regulator used in this embodiment.

In FIG. 5, there are provided a support portion 201, a valve shaft 202, a diaphragm 203, a valving element 204, and an outlet flow path 205.

First, an operation of the regulator of this example will be described.

The pressure on an upper surface of the diaphragm is represented by P₀; the primary pressure at an upstream of the valve (lower side of the valving element 204) is represented by P₁; the pressure at a downstream of the valve (outlet flow path 205) is represented by P₂; the area on the fuel reservoir side (lower surface) of the valve is represented by S₁; the area of a portion that is in contact with the flow path on the fuel electrode side (area obtained by subtracting from S₁ an area of a piston and an area of a seal portion) is represented by S₁′; the area on the atmosphere side of the diaphragm (upper surface) is represented by S₂; and the area of a portion being into contact with the fuel (lower surface) (area obtained by subtracting from S2 the area of the piston) is represented by S₂′. At this time, based on the balance of the pressures, the conditions for opening the valve is indicated by P₁S₁−P₂S₁′<P₀S₂−P₂S₂′.

In particular, in a case where the areas of the piston and seal surface are sufficiently small with respect to the areas of the diaphragm and valve, the condition of (P₁−P₂)S₁<(P₀−P₂)S₂ is established.

When P₂ is higher than the pressure satisfying the condition, the valve is closed, and when P₂ is lower than the pressure, the valve is opened. Thereby, P₂ can be maintained constant.

By adjusting the area of the valve, the area of the diaphragm, the length of the valve shaft, the thickness of the diaphragm, or the like, the pressure and the flow rate at which the valve is opened/closed can be set optimally.

Next, an operation in a case where the regulator according to this example is mounted on the fuel cell system will be described.

The primary side of the micro valve is connected to the fuel reservoir 102. The outlet flow path 205 is connected to the anode of the fuel cell 101, and a surface of the diaphragm 203 opposite to the outlet flow path is in contact with the cathode (outside air).

When power generation is started, the fuel is consumed in the anode, whereby the pressure of the fuel in the fuel flow path is reduced.

The diaphragm 203 is deflected to the fuel flow path side due to a differential pressure between the outside air pressure and the pressure in the fuel flow path, so that the valving element 204 directly connected to the diaphragm 203 via the valve shaft 202 is depressed, thereby opening the valve.

Thereby, the fuel is supplied from the fuel reservoir 102 to the anode. When the power generation is completed and the pressure in the fuel flow path is recovered, the diaphragm 203 is pushed up, thereby closing the regulator.

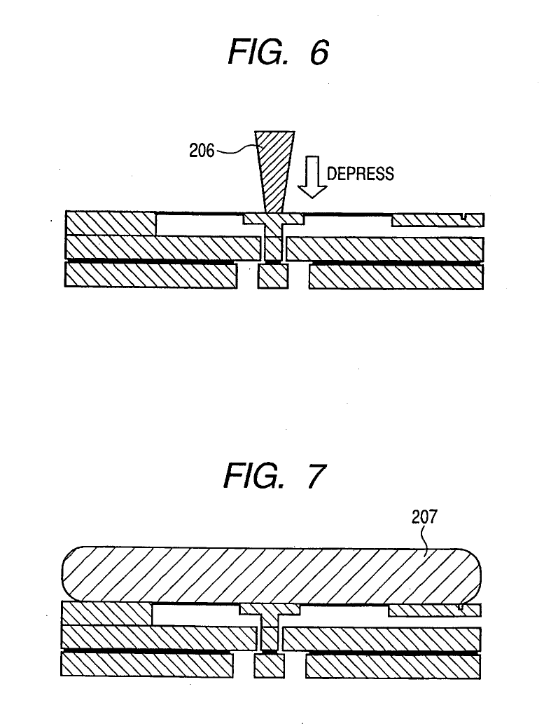

FIG. 6 is a sectional view of a structure in which, for the regulator according to this example, a pin 206 is used as the mechanism 105 for increasing the pressure according to the above embodiment.

In order to increase the pressure in the fuel flow path, the diaphragm 203 is depressed by pushing the pin 206, thereby enlarging the opening degree of the regulator, thus leading to an increase in flow rate. In order to bring the pressure in the fuel flow path to the original state, it is only necessary to return the pin to its original position.

Further, FIG. 7 is a sectional view of a structural example in which, for the regulator of this example, a chamber filled with an operating fluid 207 is disposed adjacent to the diaphragm 203 as the mechanism 105 for increasing the pressure according to the above embodiment.

In order to increase the pressure in the fluid flow path, the operating fluid 207 is pushed to depress the diaphragm 203 to open the regulator, thereby increasing the flow rate.

Further, by allowing the operating fluid 207 to expand or to be vaporized by heat, the diaphragm 203 can be depressed.

As described above, when the regulator is used as a fuel supplying valve, no energy is required for driving during normal operation, so that the power consumption can be reduced, and the structure is simplified as compared to an electromagnetic valve or the like, so that the size of the system can be reduced.

### Example 3

In Example 3, description will be made of a structural example in which a relief valve, which opens at a predetermined pressure, is used for the second valve 104 according to the embodiment illustrated in FIG. 1 described above.

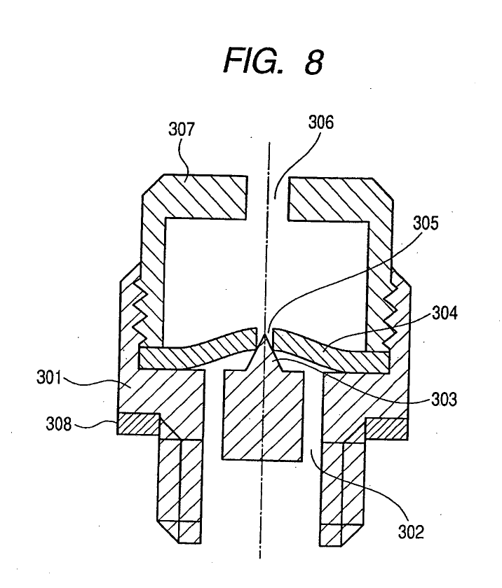

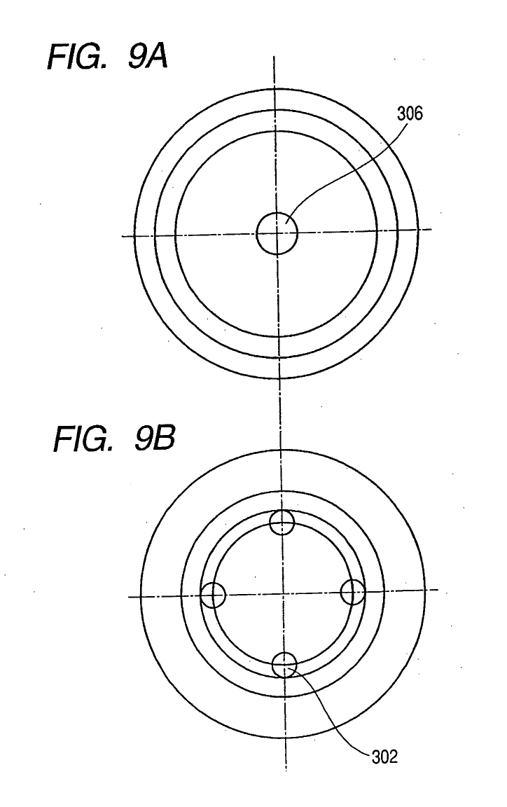

FIG. 8 illustrates a structure of the relief valve of this example. Further, FIGS. 9A and 9B are a plan view and a bottom view of the relief valve, respectively.

In FIGS. 8, 9A, and 9B, there are provided a substrate 301, a fluid inlet 302, a valve seat 303, a diaphragm 304, a flow path 305, a fluid outlet 306, a lid 307, and a seal 308.

In this example, the substrate 301 has the fluid inlet 302 and the valve seat 303. As the material of the substrate, there can be employed a metallic material such as stainless steel or aluminum, and a plastic material such as an acrylic resin.

The diaphragm 304 is made of an elastic material and has a flow path at a center thereof.

Examples of the material of the diaphragm include a plastic material such as fluororubber, silicon rubber, or urethane rubber, and a metallic material such as stainless steel, phosphor bronze, or beryllium.

In a case where the metallic material is used, in order to obtain a larger displacement by a smaller force, the metallic material may be formed in a corrugated shape.

After the diaphragm 304 has been disposed on the substrate, the diaphragm 304 is fixed thereto by the lid 307 having the fluid outlet.

The relief valve assembled as described above is attached to the flow path via a screw portion.

The screw portion has the seal 308, which prevents the fluid from leaking out through the screw portion.

For the seal 308, silicon rubber, fluororubber, or the like is used.

In a case where a metallic material is used for the diaphragm 304, in order to enhance the sealing property, a portion that comes into contact with the valve seat 303 may be additionally provided with a member made of a rubber material such as silicon rubber or fluororubber. On the other hand, in a case where a rubber material is used for the diaphragm 304, the side of the diaphragm 304 opposite to the side which comes into contact with the valve seat 303 may be reinforced with a rigid material such as a metal.

For example, in the relief valve mounted onto the fuel cell system of the present invention, the material of the diaphragm 304 is silicon rubber, the diameter thereof is 5 mm, the thickness thereof is 0.8 mm, the diameter of the flow path 305 is 0.5 mm, and a displacement by 0.07 mm is applied to the diaphragm 304 by the valve seat 303.

In this case, the relief valve is opened when the pressure in the fuel flow path exceeds 30 kPaG. When the pressure is within the range from 50 kPaG to 100 kPaG, the flow rate is about 270 to 390 sccm. Therefore, without damaging the fuel cell, the pressure in the fuel flow path can be released.

Further, the valve itself is not damaged at a pressure up to about 900 kPaG and has a sufficient mechanical strength.

Moreover, the natural frequency is about 670 kHz, which means that the response speed thereof is sufficient.

Next, description will be made of an impurity discharging method of the present invention in a case where the relief valve of this example is mounted.

First, when the purge instruction is issued according to the flow chart of FIG. 3, the mechanism 105 for increasing the pressure in the fuel flow path issues to the first valve 103 an instruction of opening the valve wider than during normal power generation.

For the first valve 103, the electromagnetic valve may be used as in Example 1, or the regulator may be used as in Example 2.

At this time, when the pressure in the fuel flow path is increased such that the pressure therein exceeds the releasing pressure of the relief valve, the relief valve is opened to perform the purge operation.

As for the completion of the purging, the mechanism 105 for increasing the pressure issues to the first valve 103 an instruction of restoring the pressure to the normal pressure, thereby reducing the pressure in the fuel flow path. When the pressure becomes lower than the releasing pressure of the relief valve, the relief valve is closed, whereby the purge operation is completed.

With the structure of this example, in particular, the relief valve can be used for a mechanism for discharging a gas in the fuel flow path to an outside of the fuel cell. Therefore, the size reduction of the system can be attained.

Alternatively, in place of the relief valve, there can be used a valve which loses a retention force at a predetermined pressure. For example, the retention force of an electromagnetic valve is designed according to the strength of a magnet, and the retention force of an electrostatic valve is designed according to the strength of an electrostatic force. By setting the pressure at which those valves lose the retention forces to be equal to the releasing pressure in the case of using the relief valve, during the normal operation, an active control can be performed, and when purging, those valves can perform the same operation as that of the relief valve.

### Example 4

In Example 4, description will be made of a structural example in which the relief valve as illustrated in FIG. 8 is used for the first valve 103 according to the embodiment illustrated in FIG. 1 described above.

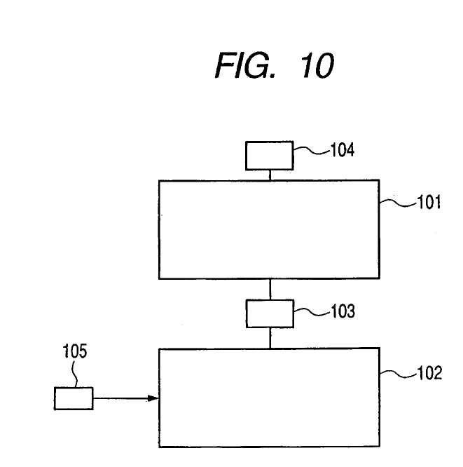

FIG. 10 illustrates a schematic diagram of a fuel cell system of this example. Incidentally, in FIG. 10, the elements which are the same as those in the fuel cell system illustrated in FIG. 1 are identified by like numerals.

In this example, for the second valve 104, an electromagnetic valve or the like may be used, or the relief valve may be used as in Example 3.

Further, the mechanism 105 for increasing the pressure in the fuel flow path acts on the fuel reservoir 102.

In this example, description will be made of an operation in a case where the relief valve is used for the second valve 104.

The setting of the pressure in this example is different from that of Example 3, so that the set pressure of the second valve 104 is lower than the set pressure of the first valve 103.

Further, an adjustment is made such that when the fuel is supplied to the inlet at a pressure at a normal use temperature of the fuel reservoir 102, the pressure at the outlet becomes a pressure optimum for driving the fuel cell. Thereby, when the pressure in the fuel reservoir 102 is within the normal range, the fuel at a pressure optimum for power generation is supplied to the anode. At that time, the second valve 104 is still closed. On the other hand, when the pressure in the fuel reservoir 102 is increased, the relief valve constituting the first valve 103 is opened, the pressure of the fuel flow path increases, and the second valve 104 is also opened, thereby releasing the pressure in the fuel flow path.

Accordingly, by increasing the pressure in the fuel reservoir, the purge operation can be performed.

Next, description will be made of a structural example in which, as the mechanism 105 for increasing the pressure, a heater is provided to the fuel reservoir. Table 1 shows the dissociation pressures at various temperatures of LaNi₅ which is a hydrogen storage alloy. As is seen from the table, the hydrogen dissociation pressure increases with increasing temperature.

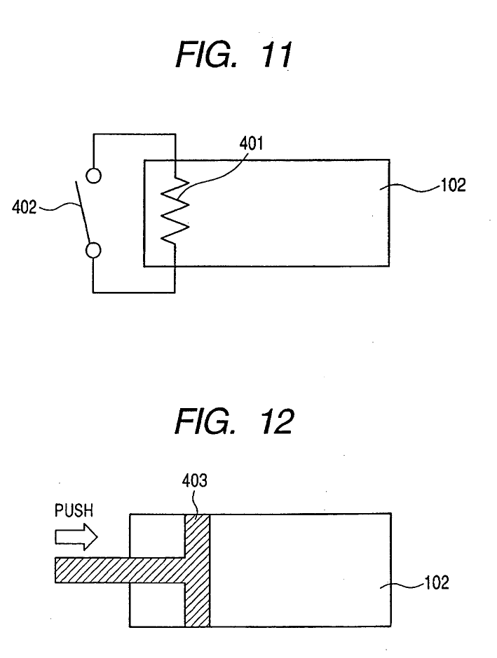

Therefore, as the mechanism 105 for increasing the pressure, a heater 401 is provided in the fuel reservoir 102 as illustrated in FIG. 11. In a case where a purge instruction is issued, a switch 402 for the heater 401 is turned on, so that the inside of the fuel reservoir is warmed, thereby increasing the pressure in the fuel reservoir.

When the pressure in the fuel reservoir 102 increases, since the first valve 103 operates such that the difference between the pressure in the fuel flow path and the pressure in the fuel reservoir 102 becomes constant, the pressure in the fuel flow path also increases.

When the pressure in the fuel flow path increases to exceed the releasing pressure for the second valve 104, the second valve 104 is opened, so that a gas in the fuel flow path is released to the outside.

Further, when the switch of the heater is turned off, the temperature in the fuel reservoir is reduced, so that the pressure in the fuel reservoir is reduced. As a result, the pressure in the fuel flow path is also reduced, so that the second valve 104 is closed.

TABLE 1

Temperature (° C.)

| | 20 | 25 | 50 | 100 |
|---|---|---|---|---|
| Dissociation Pressure | 0.15 | 0.20 | 0.40 | 2.0 |
| (MPa) | | | | |

The mechanism for increasing the pressure can be realized by, in addition to the above examples, making the volume inside the fuel reservoir variable and pushing a piston 403 as illustrated in FIG. 12. Further, when the pressure in the fuel reservoir is lower than the damaging pressure for the fuel cell 101 at a normal temperature, the first valve 103 may be omitted.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-109425, filed Jul. 11, 2006, and No. 2007-145159, filed May 31, 2007, which are hereby incorporated by reference herein in their entirety.

What is claimed is:

1. A fuel cell system, comprising:
a fuel cell having a power generating portion;
a fuel flow path for allowing a fuel gas supplied from a fuel supply source to flow in the fuel cell system;
a pressure control mechanism for controlling a fuel gas pressure in the fuel flow path to be higher than a normal operating pressure; and
an impurity discharging mechanism which operates based on a control due to a higher pressure of the pressure control mechanism to discharge an impurity in the fuel flow path to an outside of the fuel cell.

2. The fuel cell system according to claim 1, further comprising a fuel reservoir as the fuel supply source.

3. The fuel cell system according to claim 1, wherein the pressure control mechanism comprises a control valve for controlling supply of a fuel provided in the fuel flow path located between the fuel supply source and the fuel cell and is configured such that a pressure in the fuel flow path can be controlled to be higher than the normal operating pressure by the control valve.

4. The fuel cell system according to claim 3, wherein the control valve is provided in a bypass flow path of the fuel flow path located between the fuel supply source and the fuel cell.

5. The fuel cell system according to claim 2, wherein the pressure control mechanism comprises a fuel pressure control device for controlling a pressure of a fuel in the fuel reservoir and is configured such that a pressure in the fuel flow path can be controlled to be higher than the normal operating pressure by the fuel pressure control device.

6. The fuel cell system according to claim 1, wherein the impurity discharging mechanism comprises a valve which opens at a predetermined pressure in a discharging portion and is configured such that the impurity in the fuel flow path can be discharged to the outside of the fuel cell by control of the valve which opens at the predetermined pressure.

7. A purging method for a fuel cell system which comprises a fuel cell having a power generating portion and a fuel flow path for allowing a fuel gas supplied from a fuel supply source to flow in the fuel cell system and in which an impurity in the fuel flow path is discharged to an outside of the fuel cell, the method comprising:
controlling a fuel gas pressure in the fuel flow path to be higher than a normal operating pressure; and
operating an impurity discharging mechanism based on a control due to the higher pressure to discharge the impurity in the fuel flow path to the outside of the fuel cell.

8. The purging method according to claim 7, wherein the control of making the fuel gas pressure higher than the normal operating pressure is performed by controlling a fuel supply device provided in the fuel flow path located between the fuel supply source and the fuel cell.

9. The purging method according to claim 7, wherein the control of making the fuel gas pressure higher than the normal operating pressure is performed by controlling a fuel gas pressure in a fuel reservoir included, as the fuel supply source, in the fuel cell system.

10. The purging method according to claim 7, wherein the discharge of the impurity to the outside of the fuel cell is performed by controlling a valve which opens at a predetermined pressure.
